(19) United States
(12) Patent Application Publication
(10) Pub. No.: US 2020/0124451 A1
(43) Pub. Date: Apr. 23, 2020

(54) ALLOCATING SINGLE PHASE FLUID FLOW CONTRIBUTION FROM MULTIPLE SOURCES USING TRACERS

(71) Applicant: RESERVOIR METRICS IP HOLDINGS, LLC, Houston, TX (US)

(72) Inventors: Wei TIAN, Houston, TX (US); Alexander J. DARNLEY, Houston, TX (US); Mitchell C. SMITHSON, Pasadena, TX (US); Christopher DEMPSEY, The Woodlands, TX (US)

(21) Appl. No.: 16/653,575

(22) Filed: Oct. 15, 2019

Related U.S. Application Data
(60) Provisional application No. 62/747,151, filed on Oct. 18, 2018.

(51) Int. Cl. G01F 1/704

(52) U.S. Cl. CPC G01F 1/7042

(57) ABSTRACT

A method to allocate single-phase fluid flow rate in a flowline system, the fluid flowing from multiple sources into a common collector. The method can include pulse injection of one or more tracers into the flowline system, and measurement of the tracer concentration downstream. The tracer concentration detection can be performed after the fluids from multiple sources commingle together. The mean transit time for each tracer can be calculated by applying the method of moments. The flow rate from each source can be further calculated by listing and solving all tracers' transport equations.

### CROSS-REFERENCE TO RELATED APPLICATION

This application claims the benefit of the filing date of U.S. provisional application No. 62/747151, filed 18 Oct. 2018. The entire disclosure of this prior application is incorporated by reference herein in its entirety for all purposes.

### BACKGROUND

This disclosure relates generally to equipment utilized and operations performed in conjunction with a subterranean well, and in specific examples to single-phase flow in a flowline manifold. In one example described below, this disclosure more particularly provides for allocation of oleic, aqueous or gaseous phase fluid contributions from respective individual sources to a common collector.

When producing from multiple wells, in many cases a single-phase fluid flows from the wells or other sources to a common collector through flowlines. A well operator typically needs to accurately allocate the fluid contribution from each source, in order to properly manage the project. One example of such need is royalty allocation.

Allocating the fluid contribution from each source generally involves measuring a flow rate from each source into the flowline, with the fluid therein commingled from other sources. Each source of oil production in this specific example could be a well, or a group of wells. In some examples, produced oil is separated from formation water at well sites, and the oil then flows through flowlines to a common collector, from where it will be further transported for refinery.

In the case of royalty allocation, the oil company needs to pay land owners based on their corresponding contribution to the total oil production. Therefore, a method is desired to allocate the oil production from individual sources contributing to the collector. However, the scope of this disclosure is not limited to use of the systems and methods described below for royalty allocation.

### BRIEF DESCRIPTION OF THE DRAWINGS

FIG. 1 is a representative schematic view of an example of a well system and associated method which can embody principles of this disclosure.

FIG. 2 is a representative graph of an example of tracer concentration in parts per billion vs. time since injection.

### DETAILED DESCRIPTION

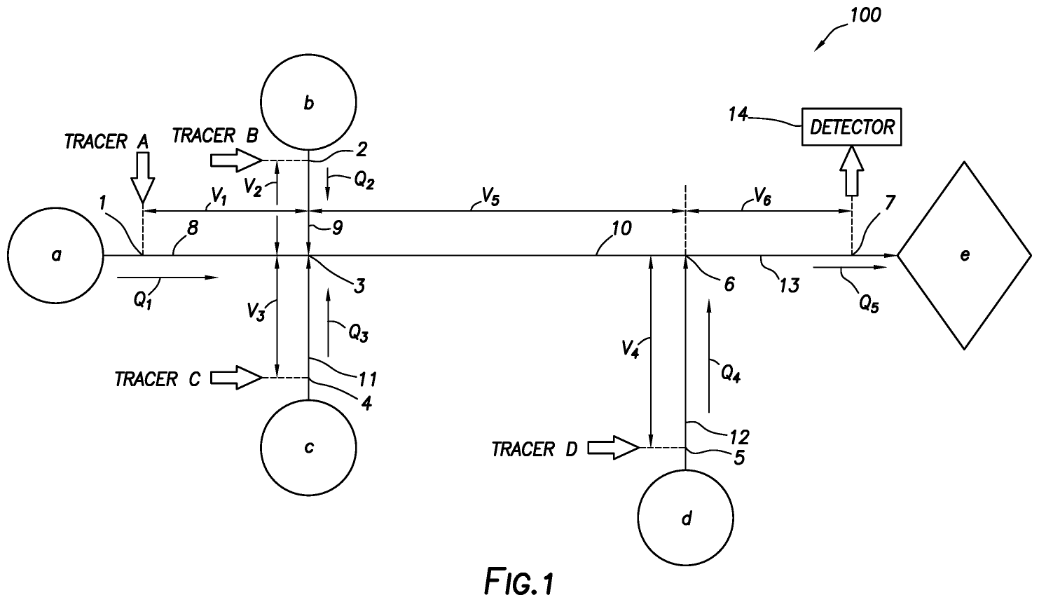

Representatively illustrated in FIG. 1 is a well fluid collection system 100 and associated method which can embody principles of this disclosure. However, it should be clearly understood that the system 100 and method are merely one example of an application of the principles of this disclosure in practice, and a wide variety of other examples are possible. Therefore, the scope of this disclosure is not limited at all to the details of the system 100 and method described herein and/or depicted in the drawings.

In the FIG. 1 example, single phase fluid is transported from source a, source b, source c and source d to a common collector e via various flowlines 8, 9, 10, 11, 12, 13. The sources a-d could each comprise a single well or a group of wells (such as, a group of wells having the same landowner), a pipeline, a separation facility, etc. The scope of this disclosure is not limited to use of any particular type of source for any of the sources a-d. Although four sources a-d are depicted in FIG. 1, any number of sources may be used in other examples.

Tracer A, Tracer B, Tracer C and Tracer D are injected into separate flowlines 8, 9, 11 and 12 at points 1, 2, 4, and 5, respectively. All of the tracers A-D eventually flow into a common flowline 13. In the FIG. 1 example, the tracers A-D are detected and their concentration measured at point 7 using a detector 14. A gas/liquid chromatography-mass spectrometer or other suitable instrument may be used for this purpose.

The flow rates from source a, source b, source c and source d are represented in FIG. 1 by Q₁, Q₂, Q₃ and Q₄, respectively. The volumes of the flowlines 8, 9, 11, 12, 10 and 13 between point 1 and point 3, between point 2 and point 3, between point 4 and point 3, between point 3 and point 6, between point 5 and point 6, and between point 6 and point 7 are represented in FIG. 1 by V₁, V₂, V₃, V₅, V₄ and V₆, respectively.

As depicted in FIG. 1, the single-phase fluids from source a, source b and source c are commingled at point 3. Such fluid further commingles with the same type fluid (e.g., substantially oil, water or gas in this example) from source d at point 6, after which the commingled fluids flow into the collector e.

It is desired in this example to know the fluid flow rate Q₁, Q₂, Q₃ and Q₄ from each source a-d. Such flow rate allocation could be used to help identify a maintenance or safety issue in the flowline system, evaluate each source's performance, provide for royalty allocation, etc. The scope of this disclosure is not limited to any particular purpose for determining the fluid flow rates Q₁, Q₂, Q₃ and Q₄.

Allocating total single-phase fluid flow contribution from the individual sources a-d is facilitated by estimating the fluid flow rate Q₁, Q₂, Q₃ and Q₄ from each source. By knowing the flow rate Q₁, Q₂, Q₃ and Q₄ from each source a-d, the contribution of each source to the common collector e is readily calculated.

One objective of this example of the method is to allocate the contribution of each of the multiple sources a-d to a total single-phase flow rate Q₅ into the common collector e. This can improve understanding and management of the flowlines 8-13 and the overall system 100.

Another objective of this example of the method is to provide for such flow rate allocation in a manner minimally intrusive to ongoing operation of the flowlines 8-13 and the overall system 100. Yet another objective of the example method is to provide for such flow rate allocation, in a manner which is easily and quickly implemented and operated in the system 100, thereby improving the system reliability.

The example method allocates the single-phase fluid flow rates Q₁, Q₂, Q₃ and Q₄ flowing from individual sources a-d to the one common collector e. In this example, the method comprises the following steps:

1) Inject a unique tracer species A, B, C, D (for example, as a pulse using a nitrogen gas driven injection device) for each respective source a, b, preferably at a point 1, 2, 4, 5 or inlet where the fluid flows from that source into the flowline system. The source could be one individual source, or a group of individual sources. In some examples, the total number of tracers injected into the system 100 may be greater than the total number of targeted sources, i.e., more than one tracer could be used to trace one source.

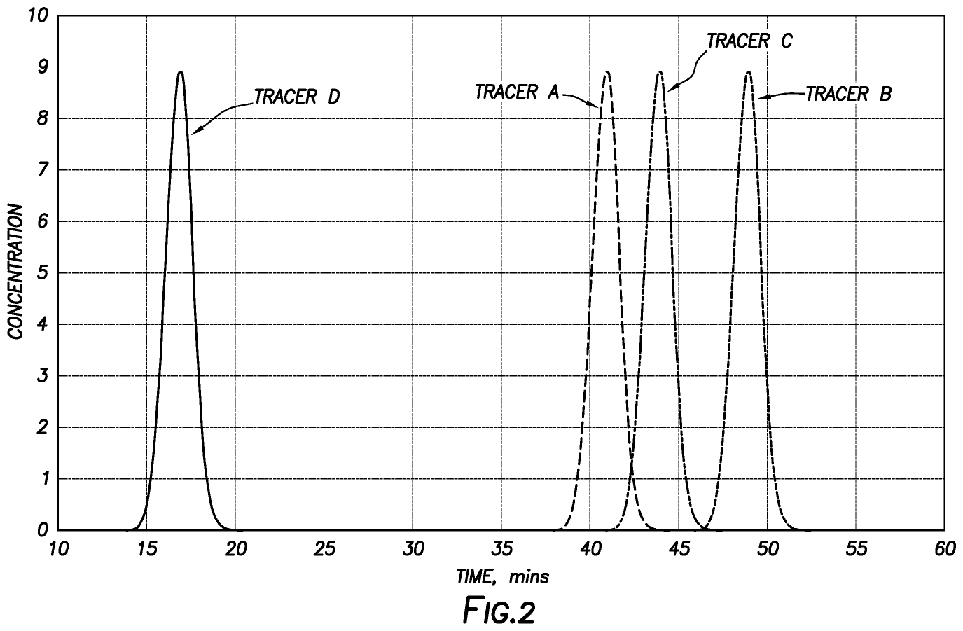

2) Measure and record all tracers' A-D concentrations at the detector 14 (which is connected to the flowline 13 downstream of point 6) after all fluids commingle together into the flowline 13, but before the fluids enter the common collector e, preferably right before (immediately upstream of) the collector. Since all the injected tracers A-D will eventually be detected by the detector 14 downstream, a tracer concentration profile will be generated as a function of time (e.g., as depicted in FIG. 2).

FIG. 2 is a representative graph of an example of tracer A-D concentration (in parts per billion) vs. time (in minutes) since injection, as detected at point 7. Each curve represents a respective tracer's A-D concentration profile.

3) Calculate the mean transit time of each tracer A-D from its injection point 1, 2, 4, 5 to the detector 14 downstream, by applying the method of moments as in the following equation:

$$\overline{{T}_{k}} = \frac{{\int }_{0}^{∞} {tC}_{k} dt}{{\int }_{0}^{∞} {C}_{k} dt} \qquad ( 1 )$$

Where,

T̅ₖ̅=the mean transit time of tracer k

Cₖ=the concentration of tracer k detected at the detector 14

t=the time lapse since the injection of tracer k

4) Allocate the flow rate Q₁, Q₂, Q₃, Q₄ from each source a-d by listing and solving transport equations for all tracers A-D. For each tracer A-D, the tracer's transport equation is listed based on the concept that the mean transit time (from step 3) equals the sum of times that the tracer flows through each segment of the flowline.

In the FIG. 1 example, the mean transit time for Tracer A equals the sum of times it travels from point 1 to point 3, from point 3 to point 6, and from point 6 to point 7. The equation for Tracer A is, therefore, as follows:

$$\overline{{T}_{A}} = \frac{{V}_{1}}{{Q}_{1}} + \frac{{V}_{5}}{{\sum }_{i = 1}^{3} {Q}_{i}} + \frac{{V}_{6}}{{\sum }_{i = 1}^{4} {Q}_{i}} \qquad ( 2 )$$

in which

Vⱼ=the volume of flowline segment j

Qᵢ=the flow rate from source i

Similarly, the equations for Tracer B, Tracer C and Tracer D are:

$$\begin{matrix}\overline{{T}_{B}} = \frac{{V}_{2}}{{Q}_{2}} + \frac{{V}_{5}}{{\sum }_{i = 1}^{3} {Q}_{i}} + \frac{{V}_{6}}{{\sum }_{i = 1}^{4} {Q}_{i}} & ( 3 ) \\ \overline{{T}_{C}} = \frac{{V}_{3}}{{Q}_{3}} + \frac{{V}_{5}}{{\sum }_{i = 1}^{3} {Q}_{i}} + \frac{{V}_{6}}{{\sum }_{i = 1}^{4} {Q}_{i}} & ( 4 ) \\ \overline{{T}_{D}} = \frac{{V}_{4}}{{Q}_{4}} + \frac{{V}_{6}}{{\sum }_{i = 1}^{4} {Q}_{i}} & ( 5 )\end{matrix}$$

Each tracer's mean transit time T̅ is obtained using Equation 1 based on the detected tracer concentration. Flowline volume V₁₋₆ for each flowline segment 8, 9, 10, 11, 12, 13 is also considered as a known variable, and can usually be obtained from a well operator.

Therefore, listing and solving the tracer transport equations (e.g., Equations 2-5) will allocate the fluid flow rate Q₁, Q₂, Q₃, Q₄ from each source a-d. The equations may be solved for the flow rates Qᵢ numerically or analytically as applicable.

During the operation, all tracers A-D may be injected at the same time to reduce the impact of unstable flow rate Q₁₋₄ from each source a-d. It is also feasible to inject tracers A-D at different times, in which case the flow rate Q₁₋₄ from each source a-d can be maintained constant during the test.

The method is not limited to the specific configuration of the system 100 as shown in FIG. 1. Different configurations of the system 100 could employ the method for allocating individual source a-d contribution, with appropriate operational design.

The tracers A-D selected for use with the method preferably satisfy the requirements of being soluble and detectable in the product stream, have negligible impact on fluid dynamic properties, have a stable property in the product stream, and a low detection threshold. In some examples, the tracers A-D could have a concentration-dependent reaction in the fluid, so that calculated mean transit time does not change due to the reaction.

Suitable tracers for use with the method comprise radioactive and chemical tracers. Radioactive tracers are chemical compounds that contain radioactive isotopes that can emit beta or gamma radiation. These isotopes can be identified by their unique features. However, due to safety and environmental concerns, radioactive tracers may not be preferred for use with the method.

Chemical tracers preferred for use in the test are conservative chemical compounds that are soluble in one specific fluid, with low partitioning coefficient in other phases. For example, oil soluble tracer should be used for a flowline system wherein oil is the primary product stream. Typical oil soluble tracers include, but are not limited to, fluorobenzenes, chlorobenzenes and bromobenzenes.

Water soluble tracer should be used for a flowline system wherein water is the primary product stream. Typical water soluble tracers include, but are not limited to, sulfonic acids, fluorobenzoic acids and chlorobenzoic acids. Gas soluble tracers should be used for a flowline system wherein gas is the primary product stream. Typical gas soluble tracers include, but are not limited to, mercaptan, nitrogen, perfluoromethylcyclopentanes and perfluoromethylcyclohexanes. However, the scope of this disclosure is not limited to use of any particular type of tracer in the system 100 and method described herein.

### EXAMPLE

In one example of the FIG. 1 system 100, each source a-d represents a well and e is a common collector/battery. Oil is separated from water by a separator at each well site, and the separated oil from each of the wells flows into the respective flowlines 8, 9, 11, 12.

Four tracers A-D are injected into the respective flowlines 8, 9, 11, 12 at the same time at point 1, point 2, point 4 and point 5, which are positioned upstream of the common flowline 13. The detector 14 at downstream point 7 monitors each tracer's A-D concentration as the commingled stream passes through point 7 to the collector e.

An example of the recorded concentrations of all four tracers A-D is depicted in FIG. 2. Applying Equation 1, the mean transit time of tracer A, tracer B, tracer C, and tracer D is calculated as 41 min., 49 min., 44 min. and 17 min., respectively.

It is known that the volumes V₁, V₂, V₃, V₄, V₅ and V₆ of the flowlines 8, 9, 11, 12, 10, 13, are equal to 600 ft³, 300 ft³, 150 ft³, 1000 ft³, 2000 ft³ and 400 ft³, respectively.

Substituting the above values into Equations 2-5 above, the flow rates Q₁₋₄ from source a, source b, source c, and source d are estimated as 50 ft³/min, 15 ft³/min, 10 ft³/min and 70 ft³/min, respectively. The total flow rate Q₅ into the collector e is estimated as 145 ft³/min, which can in some examples be independently verified or confirmed by use of a flowmeter (not shown) in the flowline 13 upstream of the collector e, if desired.

It may now be fully appreciated that the above disclosure provides significant advancements to the art of allocating contributions from each of multiple sources to a well fluid collection system. A tracer A-D can be injected into the system 100 downstream of each source a-d, and the tracer corresponding to each of the sources can be detected after the fluids from all of the sources have been commingled upstream of a collector e.

The above disclosure provides to the art a method to allocate single-phase fluid flow rate in a well fluid collection system 100 in which well fluids flow from multiple sources a-d and are commingled into a common collector e. In one example, the method can comprise: injecting multiple tracers A-D into the system 100, each of the tracers being injected downstream of a respective one of the sources a-d; measuring a concentration of each of the tracers A-D in the commingled fluids from the multiple sources a-d; calculating a mean transit time T̅ for each of the tracers A-D; and solving a transport equation for each of the tracers A-D, thereby determining a flow rate Q₁₋₄ from each of the sources a-d.

Each source a-d may comprise one or more subterranean wells.

The well fluids may comprise at least one of oil, water and gas.

The injecting step may comprise injecting the tracers A-D into the system 100 simultaneously.

The injecting step may comprise injecting a total number of tracer A-D species which is no less than a total number of the sources a-d.

The injecting step may comprise injecting at least one unique tracer species downstream of each respective one of the sources a-d.

The tracers A-D may be selected from radioactive tracers and chemical tracers. The tracers A-D are preferably soluble and detectable in the commingled well fluids.

The injecting step may comprise injecting the tracers A-D at different times. A flow rate Q₁₋₄ from each source a-d preferably does not change between the injecting and the measuring steps.

The calculating step may comprise applying the method of moments.

Also described above is a method of determining a fluid flow rate Q₁₋₄ from each of multiple respective sources a-d into a common collector e. In one example, the method can comprise: injecting multiple tracers A-D into respective multiple flowlines 8, 9, 11, 12, each of the flowlines being downstream of a respective one of the sources a-d; measuring a concentration of each of the tracers A-D in commingled fluids from the sources a-d; calculating a mean transit time T̅ for each of the tracers A-D; and solving a transport equation for each of the tracers A-D, thereby determining the flow rate Q1-4 from each of the sources a-d.

The injecting step may be performed by pulse injection of the tracers A-D into each of the respective flowlines 8, 9, 11, 12. Such pulse injection can be achieved by, but is not limited to, a nitrogen gas driven device.

The tracers A-D may be selected from the group consisting of fluorobenzenes, chlorobenzenes and bromobenzenes for tracing oil flow.

The tracers A-D may be selected from the group consisting of sulfonic acids, fluorobenzoic acids and chlorobenzoic acids for tracing water flow.

The tracers A-D may be selected from the group consisting of mercaptan, nitrogen, perfluoromethylcyclopentane and perfluoromethylcyclohexane for tracing gas flow.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method to allocate single-phase fluid flow rate in a well fluid collection system in which well fluids flow from multiple sources and are commingled into a common collector, the method comprising:
injecting multiple tracers into the system, each of the tracers being injected downstream of a respective one of the sources;
measuring a concentration of each of the tracers in the commingled fluids from the multiple sources;
calculating a mean transit time for each of the tracers; and
solving a transport equation for each of the tracers, thereby determining a flow rate from each of the sources.

2. The method of claim 1, in which each source comprises one or more subterranean wells.

3. The method of claim 1, in which the well fluids comprise at least one of the group consisting of oil, water and gas.

4. The method of claim 1, in which the injecting comprises injecting the tracers into the system simultaneously.

5. The method of claim 5, in which the injecting comprises injecting a total number of tracer species which is no less than a total number of the sources.

6. The method of claim 1, in which the injecting comprises injecting at least one unique tracer species downstream of each respective one of the sources.

7. The method of claim 1, in which the tracers are selected from radioactive tracers and chemical tracers, and wherein the tracers are soluble and detectable in the commingled well fluids.

8. The method of claim 1, in which the injecting comprises injecting the tracers at different times.

9. The method of claim 8, in which a flow rate from each source does not change between the injecting and the measuring.

10. The method of claim 1, in which the calculating comprises applying the method of moments.

11. A method of determining a fluid flow rate from each of multiple respective sources into a common collector, the method comprising:
injecting multiple tracers into respective multiple flowlines, each of the flowlines being downstream of a respective one of the sources;
measuring a concentration of each of the tracers in commingled fluids from the sources;
calculating a mean transit time for each of the tracers; and
solving a transport equation for each of the tracers, thereby determining the flow rate from each of the sources.

12. The method of claim 11, in which each source comprises one or more subterranean wells.

13. The method of claim 11, in which the well fluids comprise at least one of the group consisting of oil, water and gas.

14. The method of claim 11, in which the injecting comprises injecting the tracers into the system simultaneously.

15. The method of claim 14, in which the injecting comprises injecting a total number of tracer species which is no less than a total number of the sources.

16. The method of claim 11, in which the injecting comprises injecting at least one unique tracer species downstream of each respective one of the sources.

17. The method of claim 11, in which the tracers are selected from radioactive tracers and chemical tracers, and wherein the tracers are soluble and detectable in the commingled well fluids.

18. The method of claim 11, in which the injecting comprises injecting the tracers at different times.

19. The method of claim 18, in which a flow rate from each source does not change between the injecting and the measuring.

20. The method of claim 11, in which the calculating comprises applying the method of moments.
